(19) United States
(12) Patent Application Publication
(10) Pub. No.: US 2009/0025396 A1
(43) Pub. Date: Jan. 29, 2009

(54) Parallel turbine fuel control valves

(75) Inventors: Rahul Mohan Joshi, Greenville, SC (US); William J. Lawson, Niskayuna, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/880,700

(22) Filed: Jul. 24, 2007

(51) Int. Cl. F02C 9/00

(52) U.S. Cl. 60/773; 60/793

(57) ABSTRACT

A fuel system for a turbine, including a plurality of fuel control valves connected to the turbine and in parallel with each other, and a controller for opening each of the control valves to pass a lower controllable fuel flow through each valve, and for further opening one of the control valves in response to a control signal for controlling the turbine.

### BACKGROUND OF THE INVENTION

1. Technical Field

The subject matter described here generally relates to power plants using combustion products as a motive fluid with power output automatically regulated by controlling the quantity of fuel, and, more particularly, to gas turbine regulation with parallel fuel control valves.

2. Related Art

Integrated Gasification Combined Cycle (or “IGCC”) power plants are one of the many types of facilities that use synthetic fuel, or “syngas,” as a source of liquid or gaseous fuel to produce power. Typically, a low-value fuel such as coal, petroleum coke, biomass, or municipal waste is converted into a mixture composed primarily of hydrogen and carbon monoxide in a process referred to a “gasification.” Steam, water, carbon dioxide, nitrogen, air, natural gas, distillate, heating oil and/or other components may also be added to the raw syngas in order to improve combustion of the mixture in a heater, boiler, turbine, and/or other thermal energy conversion device.

Syngas typically has a heating value that is three to eight times lower than that of natural gas. Consequently, for a given load, significantly larger quantities of fuel must be injected into a turbine running on syngas, than the same turbine running on natural gas, distillate, or other, conventional fuels. Syngas sources are also prone to fluctuate in the quantity and quality of fuel that they produce. Consequently, many operators prefer to be able run their turbines with alternative, or backup, fuel sources, especially during startup when the high hydrogen content of some syngas makes it particularly dangerous to use. Such “fuel flexibility” requirements present a variety of challenges for power plant operations.

In order to maintain the output of the turbine, or other power plant, as close as possible to an operating setpoint, the fuel supply system is typically provided with one or more control valves in the fuel supply line. These control valves manipulate the fuel flow to the turbine in order to compensate for any load disturbances and keep the turbine running at the appropriate speed. For instance, an English-language abstract of Korean Patent Publication No. 10031106913 discloses a dual fuel system for a gas turbine including separate gas fuel and liquid fuel control valves. In another arrangement, an English-language abstract of Japanese Patent Publication No. JP2003161168 discloses two fuel control valves arranged in parallel upstream of a gas turbine combustor.

General information about control valves is available in the “Control Valve Handbook,” fourth edition, from Fisher Controls International LLC, a member of the Emerson Process Management business division of Emerson Electric Co. in Marshalltown, Iowa, USA and elsewhere. The control valve assemblies discussed in that reference typically consist of a valve body and internal trim parts, an actuator to provide the motive power to operate the valve, and a variety of additional valve accessories, which can include positioners, transducers, supply pressure regulators, manual operators, snubbers, limit switches, and/or other devices. A controller then provides an appropriate signal for actuating the valve in response to information about the status of one or more of the process variable(s) being controlled. Various other aspects of process control arc further discussed in “Instrumentation & Control: Process Control Fundamentals” and other publications from PAControl.com industrial automation training.

The style and the sizing of these control valves can have a significant impact on the overall performance of the turbine. While the valves must be large enough to pass the required flow under all possible process contingencies and fuel types, they must also not be too large to provide adequate process control. In this regard, each control valve design has a “flow characteristic” that describes the relationship between flow through the valve and the movement of the valve closure member. This relationship is often expressed in terms of a percentage of a rated maximum controllable flow through the valve versus a percentage of “travel” movement of the closure member from a closed position to rated, fully open position.

The term “rangeability” is used to express the ratio of the rated maximum to minimum controllable flow rates for which the deviation from the specified flow characteristic does not exceed specified limits. As a general rule of thumb, these maximum and minimum controllable flow rates usually occur around ninety percent travel and ten percent travel, respectively. Consequently, operators generally operate control valves within these travel limits. Good rangeability is particularly important for turbine fuel control valves in flexible fuel applications where fuel flow rates can vary widely depending upon the energy content of the fuel and/or the load on the turbine at any particular time. In most cases, wide rangeability is preferred for enhanced operability. However, even if a control valve with sufficiently high rangeability is available, such valves are generally expensive to manufacture due to the close tolerances that are required between the disc closure member and the scat.

Even with good rangeability, oversizing the control valve can still hurt process variability in at least two ways. First, an oversized valve generally puts too much gain in the valve, leaving less flexibility in adjusting the controller to reduce process variability. The second way oversized valves hurt process variability is that they are likely to operate more frequently at smaller valve opening positions, which have a disproportionately large flow change for a given increment of valve travel. This phenomenon can greatly exaggerate the process variability associated with the “dead band” range through which a small reverse in input signal from the controller does not cause any observable change in the position of the valve closure member.

### BRIEF DESCRIPTION OF THE INVENTION

These and other aspects of such conventional approaches are addressed here by providing, in various embodiments, a method of controlling a turbine having a plurality of fuel control valves arranged in parallel. In one embodiments, each of the control valves is opened to pass approximately a lower controllable fuel flow through each valve; and one of the control valves is further opened in response to a control signal for controlling the turbine.

Also disclosed here is a power plant including a turbine; a plurality of fuel control valves connected to the turbine and in parallel with each other; and a controller for opening each of the control valves to pass approximately a lower controllable fuel flow through each valve, and for further opening one of the control valves in response to a control signal for controlling the turbine

Another embodiment disclosed here generally relates to a fuel system for a turbine including a plurality of fuel control valves for connecting to the turbine and in parallel with each other; and a controller for opening each of the control valves to pass approximately a lower controllable fuel flow through each valve, and for further opening one of the control valves in response to a control signal for controlling the turbine.

### BRIEF DESCRIPTION OF THE DRAWINGS

Various aspects of these and other embodiments will now be described with reference to the following figures (“Figures”) which are not necessarily drawn to scale, but use the same reference numerals to designate corresponding parts throughout each of the several views.

FIG. 1 is a schematic piping diagram illustrating a fuel system for a power plant.

FIG. 2 illustrates valve positions for the fuel system of FIG. 1 in a non-synthetic fueling configuration, where valves in the open position are depicted as un-shaded and valves in the closed position are depicted as un-shaded.

FIG. 3 illustrates valve positions for the fuel system of FIG. 1 in a synthetic fueling configuration.

FIG. 4 is a schematic timing diagram illustrating travel of the control valves shown in the piping diagram of FIG. 3.

FIG. 5 illustrates valve positions for the fuel system of FIG. 1 in an inert purge configuration mode.

### DETAILED DESCRIPTION OF THE INVENTION

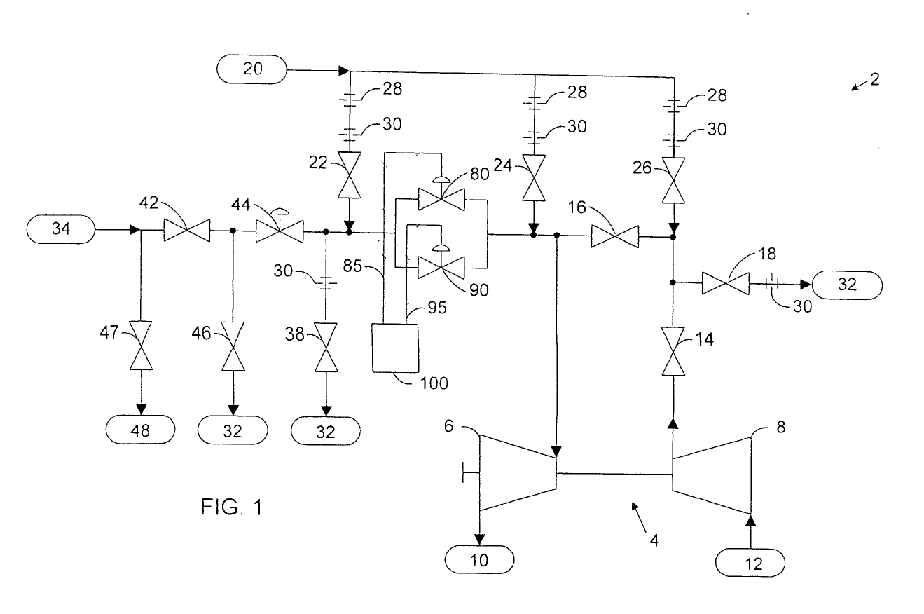

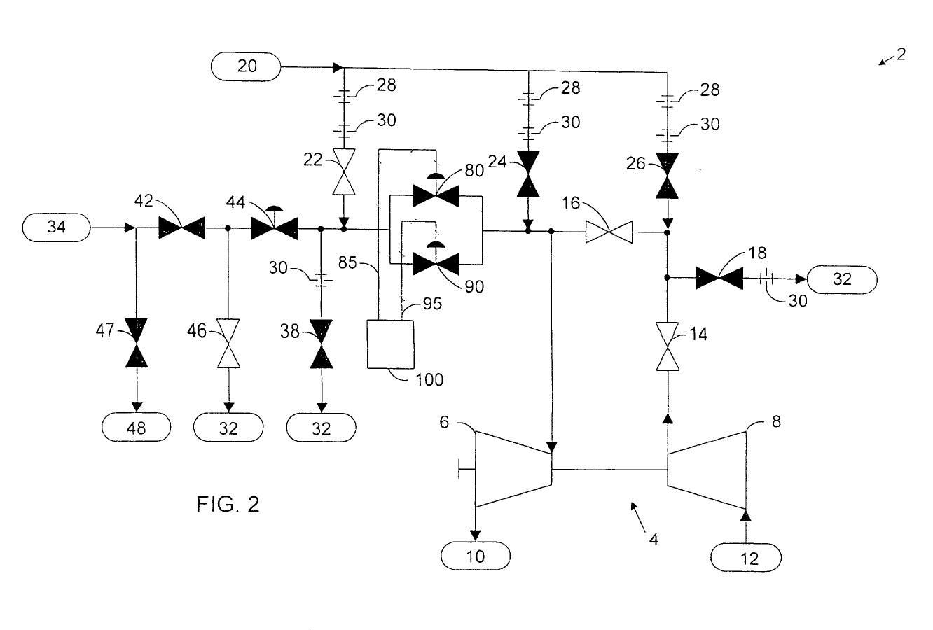

FIG. 1 is a schematic piping diagram illustrating a fuel system 2 for use with a power plant 4. FIG. 1 shows the fuel system 2 with all valves in an open configuration, while FIGS. 2, 3, and 5, show certain of the valves in a closed configuration, designated by black filling, for typical operating configurations or modes of the fuel system 2. Although the illustrated power plant 4 includes a gas turbine 6 and a compressor 8, a variety of other types of power plants may also be used with the fuel system 2, including those with oil-fired turbines, steam turbines, boilers, heaters, generators, etc. The fuel system 2 may also be implemented in a variety of other piping layouts and configurations other than the exact configuration illustrated here. For example, some or all of the fuel system 2 may be included as part of the turbine 6, or other part of the power plant 4.

For the schematic piping configuration example illustrated in these figures, the turbine 6 receives synthetic fuel, non-synthetic fuel, nitrogen, and air through the fuel system 2. However, a variety of other fluids may also be provided in lieu of, or in addition to, these fluids. The fuel and air is burned and then discharged to the turbine exhaust outlet port 10, and/or purged through various vents as described in more detail below. The turbine 6 powers the compressor 8 which receives air at the compressor air inlet port 12. During normal operation of the turbine 6 and compressor 8, a portion of the compressor pressurized discharge air at the outlet of the compressor 8 is sent to the inlet of the turbine 6 through the upstream compressor discharge purge valve 14 and a downstream compressor discharge purge valve 16. Although the compressor discharge vent valve 18 is normally closed when operating in that mode, the compressor vent valve 18 may be opened in order to vent compressor pressurized discharge air or nitrogen from the piping cavity between closed valves as described in more detail below.

The fuel system 2 illustrated here is also provided with a nitrogen inlet port 20 for supplying nitrogen gas to the system as a medium for purging the contents of the system with a dry, inert gas. However, a wide variety of other fuel supplements and/or purging materials, such as steam, carbon dioxide, and other inert media, may also be provided to the fuel system 2 via the nitrogen inlet port 20, and/or via other ports not illustrated here. For the illustrated configuration, nitrogen from the nitrogen inlet port 20 is supplied through three branches leading to the nitrogen supply valves 22, 24, and/or 26. Each of these parallel branches in the nitrogen supply line is provided with a flow measuring orifice 28 for measuring the flow of nitrogen through the corresponding nitrogen supply valve 22, 24, or 26. A restriction orifice 30 is also provided in each branch for controlling the flow of nitrogen through the corresponding nitrogen supply valves 22, 24, or 26. Additional restriction orifices 30 and/or flow measuring orifices (not shown) are similarly provided downstream of the compressor discharge vent valve 18 and upstream of the piping cavity vent valve 38 for controlling flow through the corresponding valves and out of the vent ports 32. However, a wide variety of other devices and/or configurations may also be used to control and/or measure the flow of fluids at these, and other, locations throughout the fuel system 2.

The fuel system 2 receives a synthetic fuel, such as syngas, from the syngas inlet port 34. Since the quality and quantity of the syngas can often vary significantly, a non-synthetic fuel is typically used to start-up the turbine 6 and/or to maintain turbine operation during syngas production capacity fluctuations. For example, the non-synthetic fuel may be liquid fuel oil or methane utility gas supplied to the inlet of the turbine 6 via piping not shown here. FIG. 2 illustrates valve positions for the fuel system 2 of FIG. 1 when only a liquid, or other such non-synthetic, fuel is being used to fire the turbine 6. The closed valves in FIG. 2 are designated with black fill.

In FIG. 2, the synthetic fuel stop valve 42 is closed so as to isolate the synthetic fuel production system (not: shown) from the rest of the fuel system 2. The synthetic fuel slop speed ratio valve 44, which helps control the synthetic fuel supply pressure to the control valves 80 and 90 (discussed below), is also closed. A piping cavity vent valve 46 is opened to a vent port 32 in order to vent any remaining fuel, air, and/or nitrogen from the cavity between the stop speed ratio valve 44 and the closed synthetic fuel stop valve 42. The vent ports 32 are typically connected to a gas flair or flare stack (not shown) for burning unusable waste gas. However, a wide variety of other collection and/or disposal techniques are also available for connecting to the vent ports 32.

The synthetic fuel recycle valve 47 is also illustrated as closed in the non-synthetic fuel configuration illustrated in FIG. 2. However, the synthetic fuel recycle valve 47 can be opened while the synthetic fuel stop valve 42 remains closed in order to allow for recirculation of the synthetic fuel back to the synthetic fuel production system (not shown), as indicated here by a synthetic fuel recirculation port 48.

At the center of the piping diagrams shown in FIGS. 1, 2, 3 and 5 are a first (or “lead”) control valve 80 and a second (or “follower”) control valve 90 arranged in parallel. Thai is to say that the fuel pressure drop across the piping branches having each of the control valve 80 and 90 will be substantially the same in the illustrated parallel configuration. Additional parallel control valves may also be provided as discussed in more detail below.

The controller 100 provides an appropriate signal to control valve 80 and 90, via signal lines 85 and 95, respectively, for actuating the valve in response to information about the stains of one or more the process variable(s) being controlled. For example, the controller 100 might receive information about the speed of the turbine 6 and signal one or both of the control valves 80, 90 to close when that speed is too high. When the turbine 6 is running on non-synthetic gas in the valve position configuration illustrated in FIG. 2, both of the control valves 80 and 90 are fully closed and the nitrogen supply valve 22 is opened to supply inert purge gas to the piping cavity between the control valves 80, 90 and the synthetic fuel stop speed ratio valve 44.

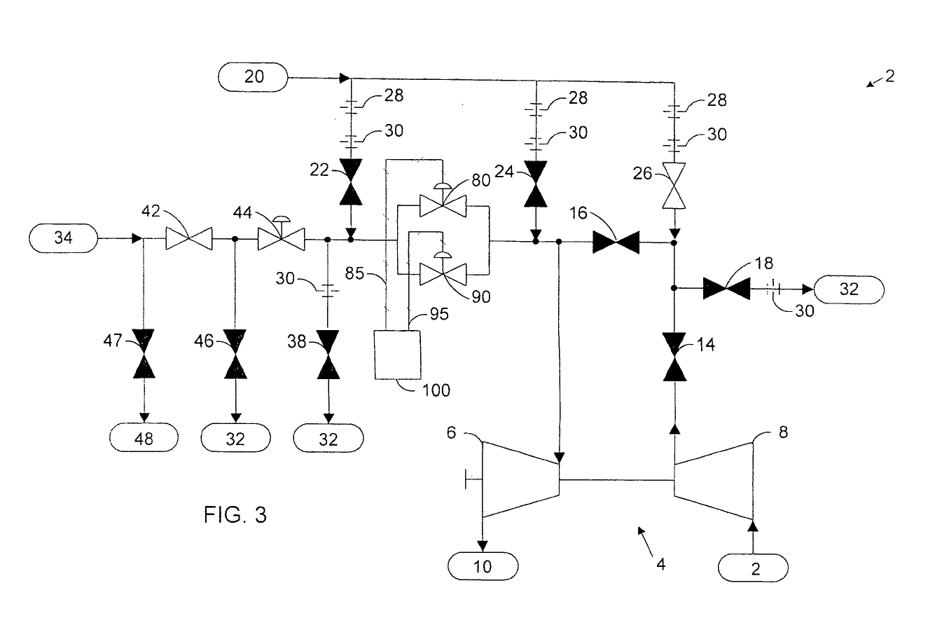

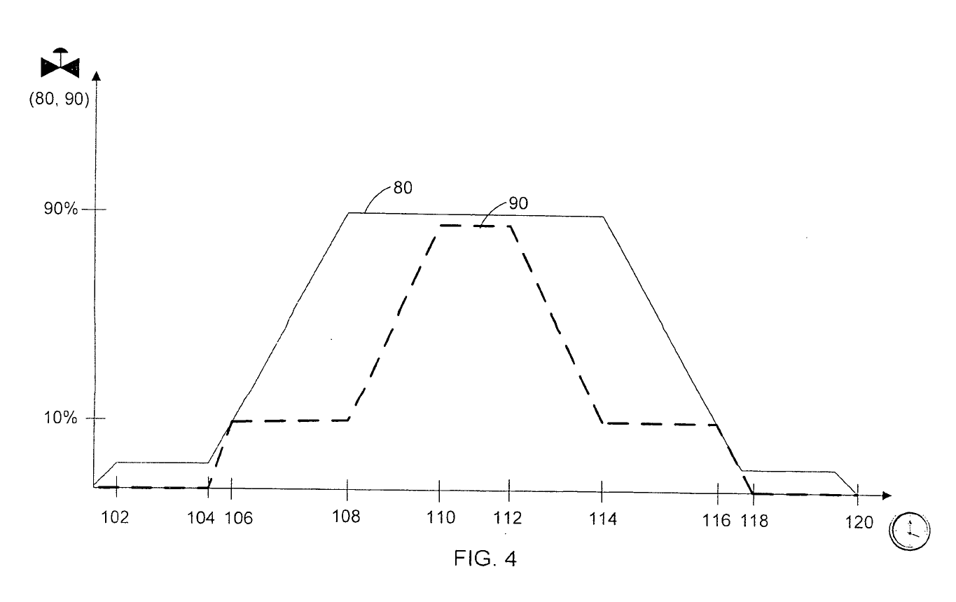

FIG. 3 illustrates valve positions for the fuel system 2 of FIG. 1 in a syngas fueling configuration. In FIG. 3, the piping cavity vent valve 46 and nitrogen supply valve 22 are closed. The synthetic fuel stop valve 42 is opened to supply synthetic fuel to the at least partially opened synthetic fuel stop speed ratio valve 44. Since at least one of the control valves 80 and 90 is also partially opened (as described below with reference to FIG. 4), synthetic fuel is provided to the fuel inlet of the turbine 6. FIG. 3 also illustrates the upstream and downstream compressor discharge purge valves 14 and 16 in a closed position with the nitrogen supply valve 26 in an open position supplying nitrogen to the inner valve piping cavity.

FIG. 4 is one example of a schematic timing diagram for a control technique using the controller 100 to actuate the control valves 80 and 90. However, the control valves 80 and 90 could also be controlled in a variety of other ways, including by manual over-ride of the controller. The vertical axis of the timing diagram in FIG. 4 represents percent travel of the control valves 80, 90 while the horizontal axis represents a typical progression over the time between initial opening and final closing of each valve. Neither axis is drawn to any particular scale.

The solid line in the body of FIG. 4 represents the actuation of the first, or lead, control valve 80 while the dashed line represents actuation of the second, or follower, control valve 90. However, the valves may be reversed and/or additional control valves may also be provided in parallel with the illustrated control valves 80 and 90. Furthermore, the periods of steady state operation may be longer or shorter than the illustrated durations, and these durations may be interrupted with other actuations of the control valves 80 and/or 90. The rates of actuation change may also be steeper or flatter than the rates shown in FIG. 4, including the relative rates of actuation between the valves. The valve actuations may also be stepwise, curvilinear, and/or non-linear over time.

For the mode of operation illustrated in FIG. 4, both of the control valves 80 and 90 start at the fully closed position illustrated in FIG. 2 with only non-synthetic fuel being provided to the turbine 6. One of the control valves 80 and 90 (shown here as first control valve 80) is initially opened a small amount to time reference 102 where the fuel system 2 is allowed to make a complete transfer to operation on synthetic fuel. As part of that transfer, the other valves in the piping system 2 have been opened and/or closed from the configuration illustrated in FIG. 2 to the configuration illustrated in FIG. 3.

Once the turbine 6 is fully transferred to synthetic fuel at the next time reference 104, both control valves 80 and 90 are opened or further opened to accommodate a lower controllable fuel flow through each valve at time reference 106. Although FIG. 4 illustrates the same travel for each control valve 80 and 90 at time reference 106, different travels may also be used. This lower controllable fuel flow may occur at a designated percentage of the rated minimum controllable flow rate for one or both of the control valves 80 and 90. A safely factor could also be provided over the 100 percent of the rated minimum controllable flow, such as ten percent safety factor at 110 percent of the rated minimum controllable flow, or a 100 percent safety factor at 200 percent of the rated minimum controllable flow for one or both of the control vales 80, 90. Any other safely factors may also be used.

Alternatively, or in addition, the lower controllable flow through one or both of the control valves 80, 90 may also occur at a designated percent travel. For example, the lower controllable fuel flow could occur at between one and twenty-five percent, five and twenty percent, live and fifteen percent, or approximately ten percent valve travel for one or both of the control valves 80 and 90. In the example illustrated in FIG. 4, the control valves 80 and/or 90 are designed so that the lower controllable flow for one or both of the valves occurs at around ten percent travel for each valve. However, the lower controllable flow rate could also be arranged to occur at other partial openings of the closure members in either or both of the control valves 80 and 90, depending upon the configuration of each of the control valves 80 and 90, the characteristic properties of the fuel mixture, and/or other process parameters and design considerations. If the lower controllable flow for control valve 80 or 90 is also the rated minimum controllable flow, then further closing of the valve 80 or 90 could be unsafe and/or lead to unacceptable levels of process variability.

Once both valves have reached approximately their lower controllable flow at time reference 106, one of the control valves (shown here as first control valve 80) is opened further and used to control the fuel flow to the turbine 6. The fuel supply to the turbine 6 continues to increase until time reference 108 when the first control valve 80 begins to operate at an upper controllable flow rate. For example, this upper controllable fuel flow may occur at a designated percentage of the rated maximum controllable flow rate and/or associated travel for one or both of the control valves 80 and 90As with the lower controllable flow discussed above, a safety factor could also be provided to the ninety (or other) percent of the rated minimum controllable flow, such as ten percent safety factor at ninety-one percent of the rated minimum controllable flow, or other safety factors based on a given percent of the rated minimum controllable flow for one or both of the control vales 80, 90.

Alternatively, or in addition, the upper controllable flow might occur at a designated percent travel for one or both of the control valves 80, 90. For example, the upper controllable fuel flow could occur at between seventy-five and one hundred percent, seventy-five and ninety-five percent, eighty-five and ninety-five percent, or at approximately ninety percent valve travel for one or both of the control valves 80 and 90. In the example illustrated in FIG.4, the control valves 80 and/or 90 arc designed so that the upper controllable flow for both of the valves 80 and 90 occurs at around at ninety percent travel for each valve. However, the upper controllable flow rate could also be arranged to occur at other partial openings of the closure members in either or both of the control valves 80 and 90, depending upon the configuration of each of the control valves 80 and 90, the characteristic properties of the fuel mixture, and/or other process parameters and design considerations. If the upper controllable flow for control valve 80 or 90 is also the rated maximum controllable flow, then further opening of the valve 80 or 90 could be unsafe and/or lead to unacceptable levels of process variability.

Since the control valves 80 and 90 are not necessarily of the same size or configuration, they may he arranged to reach their upper and/or lower controllable flow rates at different times and/or travel percentages. A safely factor may also have been added to the rated maximum and/or minimum controllable flow rates so that operators are able to safely overshoot the specified levels without significantly affecting the controllability of the fuel system 2. Furthermore, the rated maximum and/or minimum controllable flow rates, and hence any corresponding upper and lower controllable flow rates, will often depend on a variety of factors such as the available pressure drop for the process, capacity of the fuel sources, control parameters such as process gain and valve gain, and fuel properties that may even be recalculated at different periods during the life of the process.

At time reference 108, the first control valve 80 has reached its upper controllable flow rate. As noted above, this upper controllable flow preferably occurs at or below the rated maximum controllable flow for the valve 80. Any additional demand for fuel is met by further opening the second control valve 90, which replaces the first control valve 80 for making further adjustments to the fuel flow. Alternatively, or in addition, the first control valve 80 may be used for decreasing the fuel flow so that the first control valve 80 operates below its upper controllable flow rate.

At time reference 110, the second control valve has opened to nearly 90% travel and both of the control valves 80 and 90 are near their upper controllable flow rates. In FIG. 4, the upper controllable flow rate for the second control valve 90 has been designated slightly lower than its maximum controllable flow rate and the upper controllable flow for the first control valve 80. In this way, additional controllable fuel flow is available through the second control valve 80 during conditions warranting additional fuel. However, various other margins of safety may also be accommodated for in the upper and/or lower controllable flow designations for each of the control valves 80 and 90.

At time reference 112, fuel flow demand begins to drop until one of the control valves (shown here as second control valve 90) reaches its lower controllable flow at time reference 114, at which time fuel control is transferred to the first control valve 80. The first control valve 80 may also be fully closed at this (or another) time. Similarly, one or both of the control valves 80 and 90 could be closed simultaneously, or intermittently.

In FIG. 4, further reductions in fuel flow after time reference 114 occur by closing the first control valve 80 between time reference 114 and time reference 116. At time reference 116, both control valves 80 and 90 have reached approximately their lower controllable flow and the second control valve 90 is moved to a fully closed position at time reference 118 while the first control valve 80 is left partly open to maintain a given fuel demand to the turbine. At time reference 120, the control valve 80 is fully closed, indicating that the fuel system 2 has been shut down or transferred back to the non-synthetic fuel.

Although the examples shown in these figures utilize only two control valves 80 and 90 arranged parallel with each other, any number of control valves may also be used. In such configurations, multiple control valves may achieve approximately upper controllable flow before one or more of other of the control valves are further opened from their approximate lower controllable flow in order to provide further incremental fuel flow changes to the power plant 4. As each succeeding control valve is opened to achieve approximately upper and/or lower controllable flow through the valve, the next succeeding valve takes over control of the turbine. Furthermore, in situations where the valves at upper and/or maximum controllable flow are no longer moderating the fuel flow, those valves might be further opened to their fully-opened, 100 percent travel position, in order to minimize pressure drop through the fuel system 2.

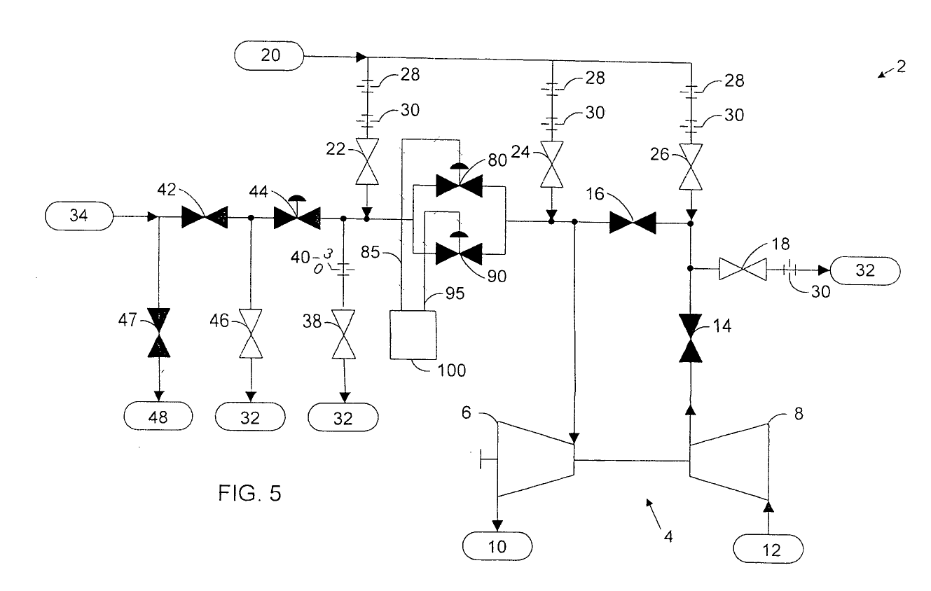

FIG. 5 illustrates valve positions for the fuel system of FIG. 1 in an inert purge configuration mode such as that which occurs during a process trip. In FIG. 5, each of the nitrogen supply valves 22, 24, and 26 is open along with each of the vent valves 18, 38 and 46. The other valves are closed.

The embodiments and modes of operation described above offer various advantages over conventional technology. For example, such parallel fuel control valve configurations provide wide rangeability without the additional cost associated with the close tolerances of high rangeability valves. These configurations are also less likely to be oversized in low fuel flow configurations and less likely to exaggerate the process variability associated with dead band at any flow rate. These advantages can be particularly useful in IGCC power plants where fuel flow requirements can vary significantly over time.

It should be emphasized that the embodiments described above, and particularly any “preferred” embodiments, are merely examples of various implementations that have been set forth here to provide an understanding of various aspects of this technology. One of ordinary skill will be able to alter many of these embodiments without substantially departing from scope of protection defined solely by the proper construction of the following claims.

What is claimed is:

1. A method of controlling a turbine having a plurality of fuel control valves arranged in parallel, comprising the steps of:
opening each of the control valves to pass a lower controllable fuel flow through each valve; and
further opening one of the control valves in response to a control signal for controlling the turbine.

2. The method recited in claim 1, further comprising the step of even further opening the one control valve to pass an upper controllable fuel flow through the one control valve.

3. The method recited in claim 2, further comprising the step of, after achieving the upper controllable fuel flow through the one control valve, even further opening another of the control valves in response to the control signal for controlling the turbine.

4. The method recited in claim 3, wherein the one of the control valves is maintained at approximately the upper controllable fuel flow during the further opening of the other of the control valves.

5. The method recited in claim 2, wherein said even further opening the one control valve step to pass the upper controllable fuel flow through the one control valve includes moving a closure member of the one control valve to approximately ninety percent travel.

6. The method recited in claim 3, wherein said even further opening the one control valve step to pass the upper controllable fuel flow through the one control valve includes moving a closure member of the one control valve to approximately ninety percent travel.

7. The method recited in claim 4, wherein said even further opening the one control valve step to pass the upper controllable fuel flow through the one control valve includes moving a closure member of the one control valve to approximately ninety percent travel.

8. The method recited in claim 1, wherein said step of opening each of the control valves to pass the lower controllable fuel flow through each valve includes moving a closure member of each of the control valves to approximately ten percent travel.

9. The method recited in claim 4, wherein said step of opening each of the control valves to pass the lower controllable fuel flow through each valve includes moving a closure member of each of the control valves to approximately ten percent travel.

10. The method recited in claim 9, wherein said step of opening each of the control valves to pass the lower controllable fuel flow through each valve includes moving a closure member of each of the control valves to approximately ten percent travel.

11. A power plant, comprising:
turbine;
a plurality of fuel control valves connected to the turbine and in parallel with each other; and
a controller for opening each of the control valves to pass a lower controllable fuel flow through each valve, and for further opening one of the control valves in response to a control signal for controlling the turbine.

12. The power plant recited in claim 11, wherein the controller further opens the one control valve to pass an upper controllable fuel flow through the one control valve.

13. The power plant recited in claim 12, wherein, alter achieving the controllable fuel flow through the one control valve, the controller even further opens another of the control valves in response to the control signal for controlling the turbine.

14. The power plant recited in claim 13, wherein the controller maintains the one of the control valves at approximately the upper controllable fuel flow during the further opening of the other of the control valves.

15. The power plant recited in claim 14, wherein the lower controllable fuel flow through each valve occurs at approximately ten percent valve travel and the upper controllable fuel flow occurs at approximately ninety percent valve travel.

16. A fuel system for a turbine, comprising:
a plurality of fuel control valves for connecting to the turbine and in parallel with each other; and
a controller for opening each of the control valves to pass approximately a lower controllable fuel flow through each valve, and for further opening one of the control valves in response to a control signal for controlling the turbine.

17. The fuel system recited in claim 16, wherein the controller further opens the one control valve to pass an upper controllable fuel flow through the one control valve.

18. The fuel system recited in claim 17, wherein, after achieving approximately the upper controllable fuel flow through the one control valve, the controller even further opens another of the control valves in response to the control signal for controlling the turbine.

19. The fuel system recited in claim 18, wherein the controller maintains the one of the control valves at approximately the upper controllable fuel flow during the further opening of the other of the control valves.

20. The fuel system recited in claim 19, wherein the lower controllable fuel flow through each valve occurs at approximately ten percent valve travel and the upper controllable fuel flow occurs at approximately ninety percent valve travel.
